(19) United States
(12) Patent Application Publication
(10) Pub. No.: US 2022/0198503 A1
(43) Pub. Date: Jun. 23, 2022

(54) Permissions Engine and Methods for Managing Cybersecurity and Privacy Compliance and Obligations

(71) Applicant: Reach Enterprises, Inc., Sunnyvale, CA (US)

(72) Inventors: Michael A. Ribero, Palo Alto, CA (US); Robert B. Vance, JR., Issaquah, WA (US); George E. Northup, Redwood City, CA (US)

(21) Appl. No.: 17/543,388

(22) Filed: Dec. 6, 2021

Related U.S. Application Data
(60) Provisional application No. 63/127,757, filed on Dec. 18, 2020.

(51) Int. Cl. G06Q 30/02; G06F 21/62

(52) U.S. Cl. CPC G06Q 30/0224; G06F 21/6254

(57) ABSTRACT

Permissions engine and methods for managing cybersecurity and privacy compliance and obligations are disclosed herein. An example method includes receiving brand information from brands, the brand information identifying consumer data that each of the brands is interested in receiving. The method includes receiving consumer permissions for the consumer data from a consumer, the consumer permissions comprising what portions of the consumer data are to be shared with the brands, on a brand-by-brand basis. The method includes receiving the consumer data, and determining when the consumer permissions and the brand information coincide. The method can also include sharing the consumer data with the brands when the consumer permissions and the brand information coincide, and providing the consumer with a reward in exchange for sharing the consumer data.

### CROSS-REFERENCE TO RELATED APPLICATIONS

This application claims the benefit and priority of U.S. Provisional Application Ser. No. 63/127,757, filed on Dec. 18, 2020, which is hereby incorporated by reference herein in its entirety as if fully set forth herein.

### TECHNICAL FIELD

This disclosure pertains to data privacy and cybersecurity compliance, and more particularly, but not by way of limitation, to permissions engines and methods for managing cybersecurity and privacy compliance and obligations.

### SUMMARY

In one embodiment, the present disclosure is directed to a method comprising receiving brand information from brands, the brand information identifying consumer data that each of the brands is interested in receiving; receiving consumer permissions for the consumer data from a consumer, the consumer permissions comprising what portions of the consumer data are to be shared with the brands, on a brand-by-brand basis; receiving the consumer data; determining when the consumer permissions and the brand information coincide; sharing the consumer data with the brands when the consumer permissions and the brand information coincide; and providing the consumer with a reward in exchange for sharing the consumer data.

In one embodiment, the present disclosure is directed to a system comprising a first database that stores brand information from brands, the brand information identifying consumer data that each of the brands is interested in receiving; a second database that stores consumer permissions for the consumer data from a consumer, the consumer permissions comprising what portions of the consumer data are to be shared with the brands, on a brand-by-brand basis; and a cloud service that is configured to: receive the consumer data; determine when the consumer permissions and the brand information coincide; share the consumer data with the brands when the consumer permissions and the brand information coincide; and provide the consumer with a reward in exchange for sharing the consumer data.

In one embodiment, the present disclosure is directed to a system comprising a processor; and a memory for storing instructions, the processor executing the instructions to: receive consumer data; determine when consumer permissions and brand information coincide; share the consumer data with the brands only when the consumer permissions and the brand information coincide; and provide the consumer with a reward in exchange for sharing the consumer data. To be sure, the only consumer data shared with a brand is that which has been specifically authorized by a consumer for a particular brand. Thus, the consumer can not only identify the consumer data it desires to share with a brand, but the brand or brands it is willing to share that data with. The consumer is entirely in control of their own data and how it is shared with a brand.

### BRIEF DESCRIPTION OF THE DRAWINGS

Exemplary embodiments are illustrated by way of example and not limitation in the figures of the accompanying drawings, in which like references indicate similar elements.

FIG. 1 illustrates an example architecture of a system of the present disclosure.

FIG. 2 is a flowchart of an example method of the present disclosure.

FIG. 3 is a flowchart of another example method of the present disclosure.

FIG. 4 is a schematic diagram of an example computer system that is configured for use in accordance with the present disclosure.

### DETAILED DESCRIPTION

### Overview

The present disclosure pertains to a permissions engine that can be configured to allow entities to freely create, share, store, and utilize digital information. Typically, digital information may be subject to onerous cybersecurity and/or privacy laws such as General Data Protection Regulation (GDPR) and California Consumer Privacy Act (CCPA).

In some embodiments, these systems and methods can be configured to allow for zero-party data and enhanced zero-party data transactions to occur between consumers and brands. Broadly, zero-party data includes any data that a customer intentionally and proactively shares with a brand, which can include preference center data, purchase intentions, purchase history and behavior, personal context, and how the individual wants the brand to recognize them—just to name a few. In some scenarios, a first party may agree to share data with a second party in exchange for something valuable to the second party. The first party is allowed to determine or specify what it is willing to share. The second party determines what data it desires and what it is willing to exchange for that desired data.

The permissions engine of the present disclosure allows consumers to proactively authorize the use of their digital information, specifically approve the merchants and brands they sanction and determine the scope of the digital information sanctioned and its corresponding use by each merchant or brand approved. This allows approved merchants and brands to freely engage in any behaviors and activity, such as targeted advertising or loyalty programs, sanctioned by the consumer, which will essentially have control over the terms of each merchant or brand engagement, something they can modify at any time.

In sum, a consumer can earn rewards from a brand in two ways. The first includes the sharing of consumer data with a brand. The brand selects the type or types of data it desires and the consumer specifies what type or types of data they are willing to share. Where these overlap, data exchange for reward may occur. A second type includes the performance of an action by a consumer. For example, a brand may desire consumers to like or review its brand or products on a social media platform. A consumer can be rewarded for that activity. Any number of activities can be requested by a brand in exchange for a reward.

The engine facilitates a direct relationship between consumers and brands and elevating it beyond simple permissions to an implicit “contract” in which the consumer proactively seeks compensation from the brand, with the engine providing oversight that ensures compliance from all parties, providing even further “protection” to the brands relative to GDPR and CCPA.

Consumers and brands can participate in a digital information marketplace where consumers select and approve the merchants and brands they wish to share their digital information with, in exchange for tangible remuneration, special treatment, and exclusive members-only activities. Because consumers are providing explicit, specific and proactive authorization for the digital information they share with merchants and brands, the permissions engine can help mediate a brand's compliance with relevant cybersecurity and/or privacy laws.

### EXAMPLE EMBODIMENTS

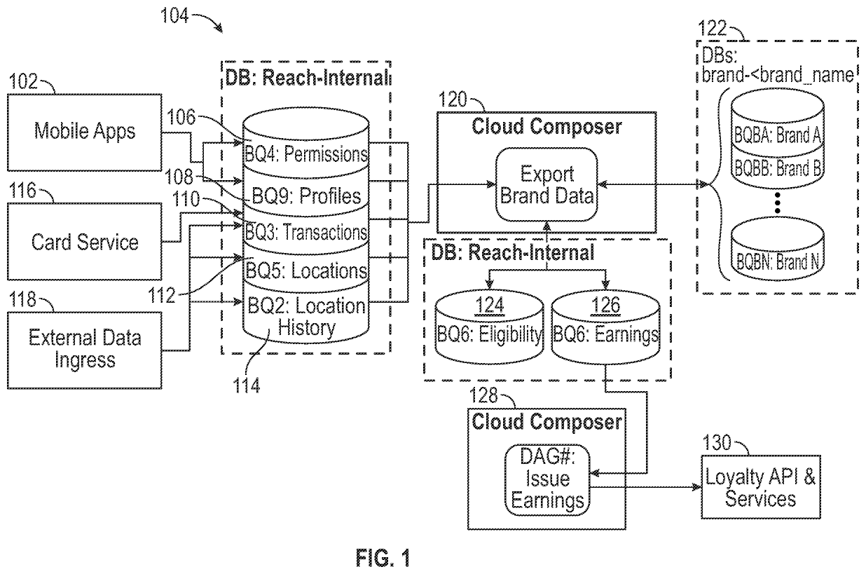

FIG. 1 illustrates an example architecture (e.g., a permissions engine 100) that can be used to implement embodiments of the present disclosure. In some embodiments, the architecture can include digital information sources. In one embodiment, a service provider can provide one or more mobile application(s) 102 that can provide a marketplace where entities such as consumers and brands can interact. Consumers can purchase goods and/or services from brands/merchants using the one or more mobile application(s) 102. Digital information is created as consumers utilize the one or more mobile application(s) 102. Prior to utilizing the one or more mobile application(s) 102, the service provider can request that the consumer sign an authorization and consent form. When the consumer signs this authorized consent form, the one or more mobile application(s) 102 can capture the consumer signing the authorization and consent form. This image can be stored, along with the signed authorization and consent form in a database 104.

Example types of digital information include that can be stored in the database 104, but are not limited to consumer permissions 106, consumer profiles 108, transaction data 110, locations 112, and location history 114. Consumer permissions can include any permission authorized by a consumer that relates to their digital information. This can include digital information pertaining to interactions with brands on the platform or other specific digital information provided by the consumer (for example, household composition, interests and aspirations, upcoming life events, search and web browsing data, email and text content, application usage, social media activity, credit history, health data, loyalty accounts, and so forth).

The consumer permissions 106 include granular permissions established by individual consumers. A consumer can identify what types of data they are comfortable with sharing with a brand. These permissions can be tailored to individual brands as well. For example, a consumer can indicate that they would prefer to share only location information with a first brand, but they would be willing to share both location and transaction data with a second brand. In some instances, a consumer can identify what data they are willing to share with a brand, as long as the brand is willing to provide a specific type of exchange. For example, a consumer can specify that they permit to share their transactional data with a brand, as long as the brand is willing to provide a specified amount of remuneration back to the consumer.

Consumers can also specify (if desired) their permissions regarding their digital information on a granular level. For example, a consumer can specify the types of digital information that can be granted to a brand on a brand-by-brand basis. For example, a consumer can specify that one brand is allowed to utilize all their digital information while a second brand can only utilize a subset of the consumer's digital information. In some instances, the consumer can grant permission to the brand to use the consumer's digital information outside the architecture. In other instances, the consumer may combine multiple criteria to determine whether data should be shared with a brand. For example, consumers may agree to share transaction data with a brand as long as it does not include health-related transactions or share location data as long as the location is not a doctor's office.

Consumer profiles 108 can be built with consumer-specific information that is volunteered by a consumer. The consumer profiles can be assembled using any of the data collected herein. Again, it is noteworthy that while profiles can be generated and stored, the sharing of information in the profile is purely at the discretion of the consumer.

A consumer profile can include any pertinent information regarding the consumer such as demographic or psychographic data—just as examples. In one embodiment, transaction data can include any data obtained when a consumer engages with a brand in the marketplace provided through the one or more mobile application(s) 102.

The depth and breadth of the information a consumer chooses to sanction are constantly expanding, as the engine captures insights and behaviors from a consumer's/member's activity on the platform. Further, the consumer is given options to append additional information to their profile, such as data from their credit report and their Linkedln account, all of which is done proactively at the consumer's discretion in exchange for tangible and intangible compensation.

Also, a consumer can be remunerated by a brand for performing specific activities or actions. For example, a user can be rewarded for writing a blog post, sharing brand content, taking a survey, or any other task that may be specified by a brand. The types of actions or activities that the consumer is willing to engage in can be specified in their consumer profile.

The depth and breadth of the information a consumer chooses to sanction is constantly expanding, as the engine captures insights and behaviors from a consumer's/member's activity on the platform. Further, the consumer is given options to append additional information to their profile, such as data from their credit report and their LinkedIn account, all of which is done proactively at the consumer's discretion in exchange for tangible and intangible compensation.

With respect to transaction data 110, this can include but is not limited to, credit card and/or debit card transactions, mobile payment transactions, and any other transaction data generated by the one or more mobile application(s) 102 executed by a mobile device or made available through a card service or other financial institution or payment processor. Advantageously for brands, if a consumer chooses to allow a brand to see its transaction data 110, the system can share these data with the brand directly. This allows the brand to see a more complete or aggregated view of the purchasing habits of the consumer across many merchants/brands. Normally, a brand is limited to only knowing the purchase history of a consumer who does business with the brand. In addition to purchasing habits, consumers can share their locations and other personal data with brand(s).

Locations 112 and location history 114 can be obtained from a mobile device on which the one or more mobile application(s) 102 are loaded. These data are included as part of the digital information stored in the database 104. The digital information provided by a consumer can be wide-ranging and can include specific actions or behaviors of the consumer that are provided in exchange for remuneration from a brand/merchant. For example, a consumer can be remunerated for writing a blog post about the brand or providing a video review on a social media platform. These examples are not intended to be limiting but are provided for descriptive purposes. A consumer can be remunerated for sharing their buying or browsing behaviors or specific engagements with brands.

While digital information has been disclosed as being obtained from one or more mobile application(s) 102, digital information can also be obtained from card services 116 and external data ingress 118. Card services 116 can provide digital information collected for a consumer that has previously agreed to provide their digital information to the database 104. A consumer can link their credit card service to the database 104 according to methods that would be known to one of ordinary skill in the art. External data ingress 118 provides a means for allowing third-party systems that may have digital information for a consumer such as a social network, a website, a third-party application, and so forth. Assuming relevant permissions and authorization exist, the consumer can link any desired external data system to the database 104. In general, the database can aggregate data from each of 106-114 to create a holistic picture of the consumer, which can be shared with a brand, per the customer's permission. In some instances, the data are aggregated in time series or time sequencing, which provides brands the ability to request data from specific periods regarding the consumer. Also, when viewed over time, patterns may be identified, along with consumer behaviors. Again, this assumes that the consumer has given permission for the brand to see their data over time and not just a particular instance of the data.

The facilitation and exchange of consumer data with brand(s) occurs in a cloud service 120, which may also be referred to as a cleanroom or exchange, which ensures that the only consumer data that is shared is that which has been approved by the consumer at their directive. The data that is shared with a brand is based on what the brand wants or desires. The cloud service 120 extracts data to be shared with a brand from the data available in the database 104.

Once data has been aggregated into the database 104, prior to sharing a consumer's data with a brand, a cloud service 120 can anonymize a consumer's data.

Each consumer can be assigned a token or other non-identifiable information. When data are requested, any personally identifiable information (PII), such as name, address, and the like, can be replaced with the token that is linked to the customer.

In some instances, the system can provide verification of a consumer through their mobile device. For example, the permissions engine 100 can verify the identity of the consumer by transmitting a verification link to the mobile device. The consumer can click on the verification link and/or perform additional identity verifying activities to ensure the consumer's identity has been verified. This verification step is important to brands who desire to market and exchange with specific individuals. The permissions engine 100 can provide additional levels of verification using transaction data 110, which can also be linked back to the mobile device. The use of transactional data and computing device verification allows for a triangulated verification of the consumer.

A cloud service 120 can obtain digital information from the database 104 and process the digital information to create export brand data. Again, the data that is used by the cloud service 120 is anonymized. The export brand data has been deanonymized prior to sharing with a brand. For example, the tokens that are present in the consumer data that has been processed by the cloud service 120 can be replaced with a consumer's PII. This can include replacing the tokens present in the consumer data with the corresponding PII stored in the database 104.

The export brand data includes any data requested by a brand that includes digital information that the brand has a right to access. Brand information databases 122 can also feed into the cloud service 120. The brand information databases 122 include pertinent information regarding the brands, such as what data the brands are interested in acquiring as well as what loyalty offerings they have available. Thus, the cloud service 120 can process together the digital information obtained for the consumers in view of the parameters established for the brands in the architecture.

These export brand data (intersection of consumer digital information, consumer permissions, and brand data) can be bifurcated or divided into internal staging databases such as an eligibility database 124 and an earnings database 126. It will be understood that each of these databases 124 and 126 operate on anonymized data as discussed above. In general, the eligibility database 124 identifies the rewards that a consumer is eligible for, in view of the data they are sharing or an action they have taken at the behest of a brand. The earnings database 126 identifies what rewards have been earned by the consumer.

It will be understood that one brand can obtain access to digital information for a consumer for each and every other brand that a consumer has engaged with on the platform. For example, if a consumer has granted seven brands access to their digital information, one or more of those seven brands can access not only digital information for the consumer-related directly to the brand but also digital information in the database 104 that pertains to the relationship between the consumer and the other six brands. Thus, the digital information for a consumer that can be accessed by a brand can include digital information that relates to engagements between the consumer and other brands that have access to the platform.

Another cloud service 128 can be utilized to issue earnings where consumers are provided earnings in loyalty currency in exchange for their provision of digital information to the architecture. The cloud service 128 can identify when a consumer has performed a service or action in exchange for a reward and/or when the consumer has shared data with a brand. An end-user, such as a consumer, can access their earnings through an API (application programming interface) or other services 130.

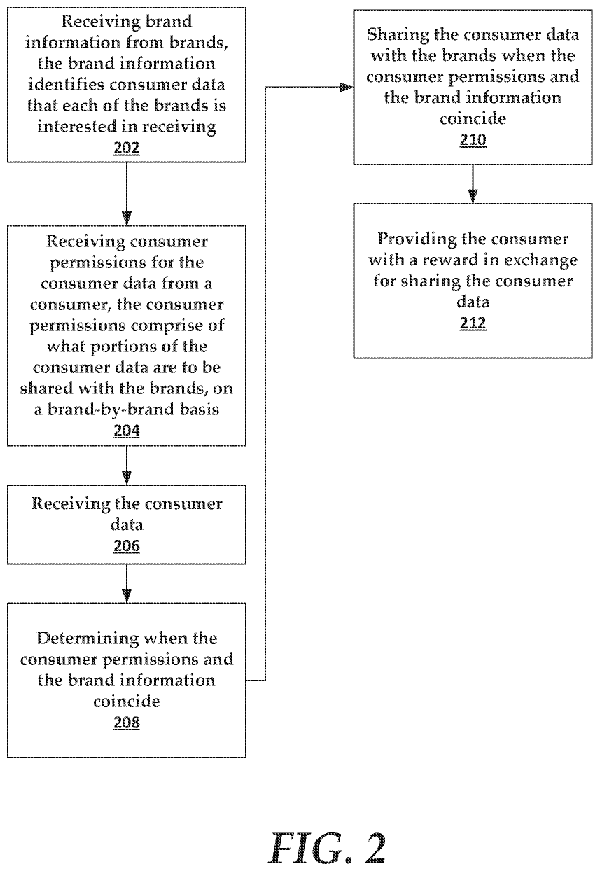

FIG. 2 is a flowchart of an example method. The method can include a step 202 of receiving brand information from brands. Generally, the brand information identifies consumer data that each of the brands is interested in receiving. Each brand can generate a profile that is stored in a brand database. The brand information can change on an ongoing basis as brand needs and preferences change over time. As noted above, the brands can also define actions or consumer behaviors that they would like to incentivize. These data can also be stored in the brand database.

Next, the method includes a step 204 of receiving consumer permissions for the consumer data from a consumer. The consumer permissions comprise of what portions of the consumer data are to be shared with the brands, on a brand-by-brand basis. That is, the consumer identifies what types of data they are willing to share with what brand(s). The consumer can also identify, on a brand-by-brand basis, what actions or activities they may perform in exchange for a reward.

The method can include a step 206 of receiving the consumer data. The consumer data can include data from mobile application(s), card service information (e.g., credit or debit), cryptocurrency transaction data, and any other transactional data that the consumer would like to share. The consumer data can also include location information and location history. As noted above, the consumer data can be aggregated in time series.

Once both consumer and brand preferences, profiles, and permissions are in place and consumer data is available, the method can include a step 208 of determining when the consumer permissions and the brand information coincide. That is, when the consumer data that the consumer is willing to share with a brand matches what consumer data the brand desires, there is a match. The overlap of these two parameters is the part of the consumer data that is shared with one or more brands.

Next, the method can include a step 210 of sharing the consumer data with the brands when the consumer permissions and the brand information coincide, and a step 212 of providing the consumer with a reward in exchange for sharing the consumer data. In some embodiments, the method can include as step of anonymizing the consumer data prior to determining when the consumer permissions and the brand information coincide. The method can include deanonymizing the consumer data prior to sharing the consumer data with the brands. As noted above, anonymization can occur through the use of a token that replaces any of the PII included in the consumer data. The token is replaced with PII during deanonymization.

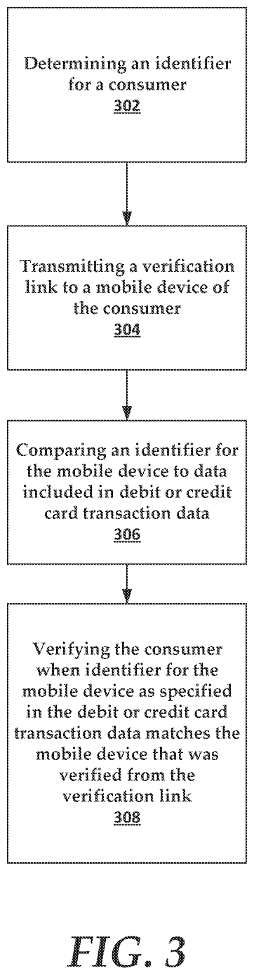

FIG. 3 is a flowchart of an example method for verifying an identity of a consumer. To be sure, brands may wish to target specific consumers. In order to ensure that a consumer whom a brand desires to target is actually the intended consumer, a verification process can be used to confirm the consumer's identity.

In some embodiments, the method can include a step 302 of determining an identifier for a consumer. In one example embodiment, the identifier is a phone number associated with a consumer's mobile device. The identifier can be linked to a device, such as a Smartphone for the user. The method can include a step 304 of transmitting a verification link to a mobile device of the consumer. The consumer can click on the link and complete the verification process.

Next, a cross-check can be completed against the phone number and other data present in the consumer's profile. For example, the method can include a step 306 of comparing an identifier for the mobile device to data included in debit or credit card transaction data. That is, credit or debit card transaction data may include a consumer's mobile number. This information can be compared against the identifier for the consumer that was involved in the link verification process.

The method includes a step 308 of verifying the consumer when identifier for the mobile device as specified in the debit or credit card transaction data matches the mobile device that was verified from the verification link.

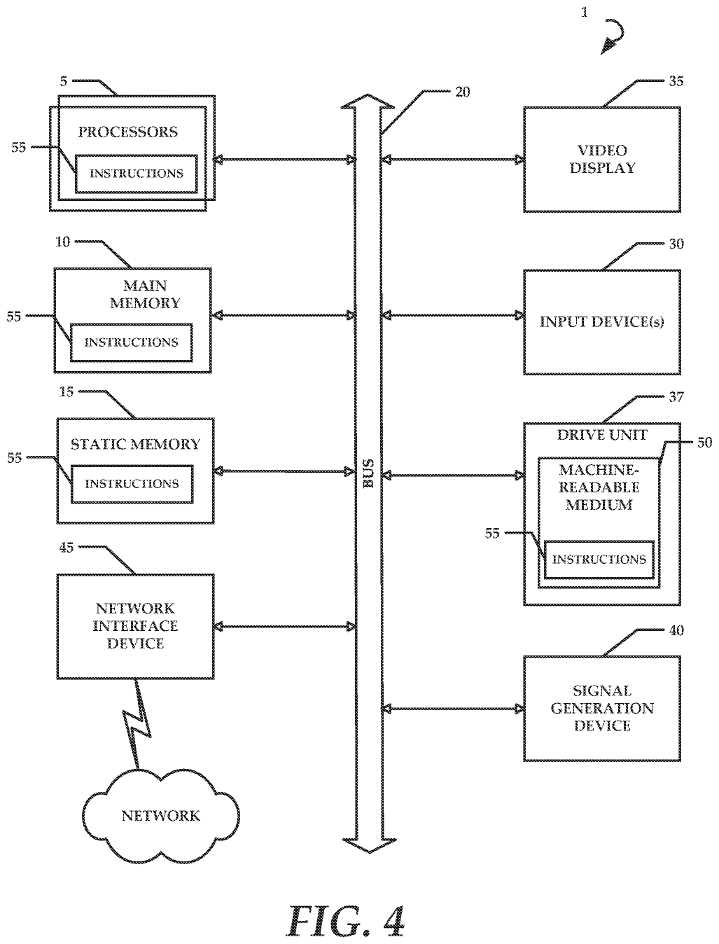

FIG. 4 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present.

The terminology used herein is for the purpose of describing particular embodiments only and is not intended to be necessarily limiting of the disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence or addition of one or more other features, integers, steps, operations, elements, components, and/or groups thereof.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In this description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

1. A method comprising:
receiving brand information from brands, the brand information identifying consumer data that each of the brands is interested in receiving;
receiving consumer permissions for the consumer data from a consumer, the consumer permissions comprising what portions of the consumer data are to be shared with the brands, on a brand-by-brand basis;
receiving the consumer data;
determining when the consumer permissions and the brand information coincide;
sharing the consumer data with the brands when the consumer permissions and the brand information coincide; and
providing the consumer with a reward in exchange for sharing the consumer data.

2. The method according to claim 1, wherein the consumer data includes application data collected from one or more mobile applications.

3. The method according to claim 1, wherein the consumer data includes transaction information from a card service.

4. The method according to claim 1, further comprising anonymizing the consumer data prior to determining when the consumer permissions and the brand information coincide.

5. The method according to claim 4, further comprising deanonymizing the consumer data prior to sharing the consumer data with the brands.

6. The method according to claim 1, wherein the consumer permissions further define consumer behaviors or actions that the consumer is willing to perform in exchange for the reward.

7. The method according to claim 1, wherein the consumer data is aggregated and time sequenced.

8. The method according to claim 1, wherein the consumer data comprises any one or more of credit card or debit card transaction data, location data, location history, consumer profile data, and combinations and/or permutations thereof.

9. The method according to claim 8, further comprising verifying an identity of the consumer by:
transmitting a verification link to a mobile device of the consumer;
comparing an identifier for the mobile device to data included in debit or credit card transaction data; and
verifying the consumer when identifier for the mobile device as specified in the debit or credit card transaction data matches the mobile device that was verified from the verification link.

10. A system comprising:
a first database that stores brand information from brands, the brand information identifying consumer data that each of the brands is interested in receiving;
a second database that stores consumer permissions for the consumer data from a consumer, the consumer permissions comprising what portions of the consumer data are to be shared with the brands, on a brand-by-brand basis; and
a cloud service that is configured to:
receive the consumer data;
determine when the consumer permissions and the brand information coincide;
share the consumer data with the brands when the consumer permissions and the brand information coincide; and
provide the consumer with a reward in exchange for sharing the consumer data.

11. The system according to claim 10, wherein the consumer data includes application data collected from one or more mobile applications.

12. The system according to claim 10, wherein the consumer data includes transaction information from a card service.

13. The system according to claim 10, wherein the cloud service is configured to anonymize the consumer data prior to determining when the consumer permissions and the brand information coincide.

14. The system according to claim 13, wherein the cloud service is configured to deanonymize the consumer data prior to sharing the consumer data with the brands.

15. The system according to claim 10, wherein the consumer permissions further define consumer behaviors or actions that the consumer is willing to perform in exchange for the reward.

16. The system according to claim 10, wherein the consumer data is aggregated and time sequenced.

17. The system according to claim 10, wherein the consumer data comprises any one or more of credit card or debit card transaction data, location data, location history, consumer profile data, and combinations and/or permutations thereof.

18. The system according to claim 10, wherein the cloud service is configured to verify an identity of the consumer by:
transmitting a verification link to a mobile device of the consumer;
comparing an identifier for the mobile device to data included in debit or credit card transaction data; and
verifying the consumer when identifier for the mobile device as specified in the debit or credit card transaction data matches the mobile device that was verified from the verification link.

19. A system comprising:
a processor; and
a memory for storing instructions, the processor executing the instructions to:
receive consumer data;
determine when consumer permissions and brand information coincide;
share the consumer data with the brands when the consumer permissions and the brand information coincide; and
provide the consumer with a reward in exchange for sharing the consumer data.

20. The system according to claim 19, wherein the brand information identifies consumer data that each of the brands is interested in receiving and the consumer permissions identify what portions of the consumer data are to be shared with the brands, on a brand-by-brand basis.
